(19) United States
(12) Patent Application Publication
(10) Pub. No.: US 2023/0379121 A1
(43) Pub. Date: Nov. 23, 2023

(54) METHOD PERFORMED BY USER EQUIPMENT, AND USER EQUIPMENT

(71) Applicant: Sharp Kabushiki Kaisha, Sakai City, Osaka (JP)

(72) Inventors: Yinan ZHAO, Shanghai (CN); Chao LUO, Shanghai (CN); Renmao LIU, Shanghai (CN)

(21) Appl. No.: 18/031,154

(22) PCT Filed: Oct. 11, 2021
(86) PCT No.: PCT/CN2021/123081

§ 371 Date: Apr. 11, 2023

(30) Foreign Application Priority Data
Oct. 14, 2020 (CN) 202011097236.3

(51) Int. Cl. H04L 5/00; H04W 72/40

(52) U.S. Cl. CPC H04L 5/0051; H04W 72/40

(57) ABSTRACT

Provided in the present invention are a method performed by user equipment, and user equipment. The method includes: receiving a PSCCH and a corresponding PSSCH of the PSCCH transmitted by another sidelink user equipment; and determining a sidelink phase-tracking reference signal (PT-RS) sequence.

### TECHNICAL FIELD

The present invention relates to the technical field of wireless communications, and in particular to a method performed by user equipment, and corresponding user equipment.

### BACKGROUND

In conventional cellular networks, all communication needs to be forwarded via base stations. By contrast, D2D communication (device-to-device communication) refers to a technique in which two user equipment units directly communicate with each other without needing a base station or a core network to perform forwarding therebetween. A research project on the use of LTE equipment to implement proximity D2D communication services was approved at the 3rd Generation Partnership Project (3GPP) RAN #63 plenary meeting in March 2014 (see Non-Patent Document 1). Functions introduced in the LTE Release 12 D2D include:
1) a discovery function between proximate devices in an LTE network coverage scenario;
2) a direct broadcast communication function between proximate devices; and
3) support for unicast and groupcast communication functions at higher layers.

A research project on enhanced LTE eD2D (enhanced D2D) was approved at the 3GPP RAN #66 plenary meeting in December 2014 (see Non-Patent Document 2). Main functions introduced in the LTE Release 13 eD2D include:
1) a D2D discovery in out-of-coverage and partial-coverage scenarios; and
2) a priority handling mechanism for D2D communication.

Based on the design of the D2D communication mechanism, a V2X feasibility research project based on D2D communication was approved at the 3GPP RAN #68 plenary meeting in June 2015. V2X stands for Vehicle to Everything, and is used to implement information exchange between a vehicle and all entities that may affect the vehicle, for the purpose of reducing accidents, alleviating traffic congestion, reducing environmental pollution, and providing other information services. Application scenarios of V2X mainly include four aspects:
1) V2V, Vehicle to Vehicle, i.e., vehicle-to-vehicle communication;
2) V2P, Vehicle to Pedestrian, i.e., a vehicle transmits alarms to a pedestrian or a non-motorized vehicle;
3) V2N: Vehicle-to-Network, i.e., a vehicle connects to a mobile network;
4) V21: Vehicle-to-Infrastructure, i.e., a vehicle communicates with road infrastructure.

3GPP divides the research and standardization of V2X into three stages. The first stage was completed in September 2016, and mainly focused on V2V and was based on LTE Release 12 and Release 13 D2D (also known as sidelink), that is, the development of proximity communication technologies (see Non-Patent Document 3). V2X stage 1 introduced a new D2D communication interface referred to as PC5 interface. The PC5 interface is mainly used to address the issue of cellular Internet of Vehicle (IoV) communication in high-speed (up to 250 km/h) and high-node density environments. Vehicles can exchange information such as position, speed, and direction through the PC5 interface, that is, the vehicles can communicate directly through the PC5 interface. Compared with the proximity communication between D2D devices, functions introduced in LTE Release 14 V2X mainly include:
1) higher density DMRS to support high-speed scenarios;
2) introduction of subchannels to enhance resource allocation methods; and
3) introduction of a user equipment sensing mechanism with semi-persistent scheduling.

The second stage of the V2X research project belonged to the LTE Release 15 research category (see Non-Patent Document 4). Main features introduced included high-order 64QAM modulation, V2X carrier aggregation, short TTI transmission, as well as feasibility study of transmit diversity.

The corresponding third stage, V2X feasibility research project based on 5G NR network technologies (see Non-Patent Document 5), was approved at the 3GPP RAN #80 plenary meeting in June 2018.

In Rel-15 NR, a phase-tracking reference signal (PT-RS) is used to track phase fluctuations over the entire transmission period (e.g. one slot) on higher frequency bands. Since the PT-RS is designed to track phase noise, the PT-RS is dense in the time domain and sparse in the frequency domain. Similarly, a sidelink PT-RS is introduced to NR sidelink. The user equipment performs phase tracking on higher frequency bands according to the received PT-RS, so as to improve demodulation performance.

The solution of the present invention mainly includes a method for determining a sidelink PT-RS sequence, and a method for determining mapping of a sidelink PT-RS in a time domain.

### PRIOR ART DOCUMENT

### Non-Patent Documents

Non-Patent Document 1: RP-140518, Work item proposal on LTE Device to Device Proximity Services
Non-Patent Document 2: RP-142311, Work Item Proposal for Enhanced LTE Device to Device Proximity Services
Non-Patent Document 3: RP-152293, New WI proposal: Support for V2V services based on LTE sidelink
Non-Patent Document 4: RP-170798, New WID on 3GPP V2X Phase 2
Non-Patent Document 5: RP-181480, New SID Proposal: Study on NR V2X

### SUMMARY

In order to address at least part of the aforementioned issues, the present invention provides a method performed by user equipment, and user equipment.

Provided in one aspect of the present invention is a method performed by user equipment, the method comprising: receiving a PSCCH and a corresponding PSSCH of the PSCCH transmitted by another sidelink user equipment; and determining a sidelink phase-tracking reference signal (PT-RS) sequence.

Optionally, the determining a sidelink PT-RS sequence comprises: determining the sidelink PT-RS sequence at least according to an index of the first OFDM symbol that carries a demodulation reference signal (DMRS) for the PSSCH within a slot.

Provided in another aspect of the present invention is a method performed by user equipment, the method comprising: acquiring first sidelink configuration information, where the first sidelink configuration information comprises bandwidth part configuration information for sidelink; acquiring second sidelink configuration information, where the second sidelink configuration information comprises resource pool information for sidelink; receiving a PSCCH and a corresponding PSSCH of the PSCCH transmitted by another sidelink user equipment; and determining related information of a sidelink PT-RS according to the first sidelink configuration information, the second sidelink configuration information, the PSCCH and the corresponding PSSCH.

Optionally, the determining related information of a sidelink PT-RS comprises: determining a sidelink PT-RS sequence; and/or determining time-domain resource mapping information of the sidelink PT-RS.

Optionally, the PSCCH carries first stage SCI, and the determining related information of a sidelink PT-RS according to the first sidelink configuration information, the second sidelink configuration information, the PSCCH and the corresponding PSSCH comprises: determining, at least according to the first stage SCI and the second sidelink configuration information, whether the other user equipment has transmitted the sidelink PT-RS; and upon determining that the other user equipment has transmitted the sidelink PT-RS, determining the related information of the sidelink PT-RS according to the first sidelink configuration information, the second sidelink configuration information, the PSCCH and the corresponding PSSCH.

Optionally, the determining the related information of the sidelink PT-RS according to the first sidelink configuration information, the second sidelink configuration information, the PSCCH and the corresponding PSSCH comprises: determining the sidelink PT-RS sequence according to the first sidelink configuration information, the second sidelink configuration information, the first stage SCI, and the corresponding PSSCH.

Optionally, the sidelink PT-RS sequence is determined at least according to a symbol index of the first OFDM symbol that actually transmits a demodulation reference signal (DMRS) for the corresponding PSSCH within a slot, and the first OFDM symbol that actually transmits the DMRS for the corresponding PSSCH is determined at least according to the first sidelink configuration information, the first stage SCI, and the second sidelink configuration information.

Optionally, the sidelink PT-RS sequence is at least determined according to a symbol index of the first OFDM symbol that carries a DMRS for the corresponding PSSCH within a slot, and the first OFDM symbol that carries the DMRS for the corresponding PSSCH is determined at least according to the first sidelink configuration information, the first stage SCI, and the second sidelink configuration information.

Optionally, the determining the related information of the sidelink PT-RS according to the first sidelink configuration information, the second sidelink configuration information, and the PSCCH and the corresponding PSSCH comprises: determining a time-domain density L_(PT-RS) of the sidelink PT-RS at least according to the first stage SCI and the second sidelink configuration information; and determining a set of time-domain OFDM symbols for the sidelink PT-RS as time-domain resource mapping information of the sidelink PT-RS at least according to any one of any OFDM symbol that actually transmits the DMRS for the corresponding PSSCH and any OFDM symbol that carries the DMRS for the corresponding PSSCH and the time domain density L_(PT-RS), where the any OFDM symbol that actually transmits the DMRS for the corresponding PSSCH or the any OFDM symbol that carries the DMRS for the corresponding PSSCH is at least determined by the first sidelink configuration information, the first stage SCI, and the second sidelink configuration information.

Optionally, the first sidelink configuration information is transmitted by a base station gNB or is pre-configured.

Optionally, the second sidelink configuration information is transmitted by the base station gNB or is pre-configured.

Optionally, the first sidelink configuration information at least comprises start indication information and length indication information of an OFDM symbol for sidelink in a slot.

Optionally, the second sidelink configuration information at least comprises configuration information of the sidelink PT-RS.

Provided in another aspect of the present invention is user equipment, comprising: a processor; and a memory storing instructions, where the instructions, when run by the processor, perform the method according to the first aspect of the present invention.

### Beneficial Effects of Present Invention

According to the method provided by the present invention, the complexity of user equipment implementation can be reduced, and channel demodulation performance can be improved.

The method for determining a sidelink PT-RS sequence provided by the present invention can ensure that transmitting user equipment and receiving user equipment generates a sidelink PT-RS sequence in the same manner, and can eliminate the need for user equipment to generate a reference signal for a symbol that does not transmit a DMRS, thereby reducing the complexity of user equipment implementation.

According to the method for determining time-domain resource mapping of a sidelink PT-RS provided by the present invention, the density of the PT-RS in a time domain can be ensured, thereby improving channel demodulation performance.

### BRIEF DESCRIPTION OF THE DRAWINGS

The above and other features of the present invention will be more apparent from the following detailed description in combination with the accompanying drawings:

FIG. 1 is a schematic diagram showing sidelink communication of LTE V2X UE.

FIG. 2 is a schematic diagram showing a resource allocation mode of LTE V2X.

FIG. 3 is a schematic diagram showing a basic procedure of a method performed by user equipment according to Embodiment 1 of the invention.

FIG. 4 is a schematic diagram showing a basic procedure of a method performed by user equipment according to Embodiment 2 of the invention.

FIG. 5 is a block diagram showing user equipment according to an embodiment of the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

In the following description, a 5G mobile communication system and its later evolved versions are used as exemplary application environments to set forth a plurality of embodiments according to the present invention in detail. However, it is to be noted that the present invention is not limited to the following embodiments, but is applicable to many other wireless communication systems, such as a communication system after 5G and a 4G mobile communication system before 5G.

Some terms involved in the present invention are described below. Unless otherwise specified, the terms used in the present invention adopt the definitions herein. The terms given in the present invention may vary in LTE, LTE-Advanced, LTE-Advanced Pro, NR, and subsequent communication systems, but unified terms are used in the present invention. When applied to a specific system, the terms may be replaced with terms used in the corresponding system.
3GPP: 3rd Generation Partnership Project
LTE: Long Term Evolution
NR: New Radio
PDCCH: Physical Downlink Control Channel
DCI: Downlink Control Information
PDSCH: Physical Downlink Shared Channel
UE: User Equipment
eNB: evolved NodeB, evolved base station
gNB: NR base station
TTI: Transmission Time Interval
OFDM: Orthogonal Frequency Division Multiplexing
CP-OFDM: Cyclic Prefix Orthogonal Frequency Division Multiplexing
C-RNTI: Cell Radio Network Temporary Identifier
CSI: Channel State Information
HARQ: Hybrid Automatic Repeat Request
CSI-RS: Channel State Information Reference Signal
CRS: Cell Reference Signal
PUCCH: Physical Uplink Control Channel
PUSCH: Physical Uplink Shared Channel
UL-SCH: Uplink Shared Channel
CG: Configured Grant
Sidelink: Sidelink Communication
SCI: Sidelink Control Information
PSCCH: Physical Sidelink Control Channel
MCS: Modulation and Coding Scheme
RB: Resource Block
RE: Resource Element
CRB: Common Resource Block
CP: Cyclic Prefix
PRB: Physical Resource Block
PSSCH: Physical Sidelink Shared Channel
FDM: Frequency Division Multiplexing
RRC: Radio Resource Control
RSRP: Reference Signal Receiving Power
SRS: Sounding Reference Signal
DMRS: Demodulation Reference Signal
CRC: Cyclic Redundancy Check
PSDCH: Physical Sidelink Discovery Channel
PSBCH: Physical Sidelink Broadcast Channel
SFI: Slot Format Indication
TDD: Time Division Duplexing
FDD: Frequency Division Duplexing
SIB1: System Information Block Type 1
SLSS: Sidelink Synchronization Signal
PSSS: Primary Sidelink Synchronization Signal
SSSS: Secondary Sidelink Synchronization Signal
PCI: Physical Cell ID
PSS: Primary Synchronization Signal
SSS: Secondary Synchronization Signal
BWP: Bandwidth Part
GNSS: Global Navigation Satellite System
SFN: System Frame Number (radio frame number)
DFN: Direct Frame Number
IE: Information Element
SSB: Synchronization Signal Block
EN-DC: EUTRA-NR Dual Connection
MCG: Master Cell Group
SCG: Secondary Cell Group
PCell: Primary Cell
SCell: Secondary Cell
PSFCH: Physical Sidelink Feedback Channel
SPS: Semi-Persistent Scheduling
TA: Timing Advance
PT-RS: Phase-Tracking Reference Signal
TB: Transport Block
CB: Code Block
QPSK: Quadrature Phase Shift Keying
16/64/256 QAM: 16/64/256 Quadrature Amplitude Modulation
AGC: Automatic Gain Control

The following is a description of the prior art associated with the solution of the present invention. Unless otherwise specified, the same terms in the specific embodiments have the same meanings as in the prior art.

It is worth pointing out that the V2X and sidelink mentioned in the description of the present invention have the same meaning. The V2X herein can also mean sidelink; similarly, the sidelink herein can also mean V2X, and no specific distinction and limitation will be made in the following text.

The resource allocation mode of V2X (sidelink) communication and the transmission mode of V2X (sidelink) communication in the description of the present invention can equivalently replace each other. The resource allocation mode involved in the description can mean a transmission mode, and the transmission mode involved herein can mean a resource allocation mode.

The PSCCH in the description of the present invention is used to carry SCI. The PSSCH associated with or relevant to or corresponding to or scheduled by PSCCH involved in the description of the present invention has the same meaning, and all refer to an associated PSSCH or a corresponding PSSCH. Similarly, the SCI (including first stage SCI and second stage SCI) associated with or relevant to or corresponding to PSSCH involved in the description has the same meaning, and all refer to associated SCI or corresponding SCI. It is worth noting that the first stage SCI, referred to as 1st stage SCI, is transmitted in the PSCCH, and the second stage SCI, referred to as 2nd stage SCI, is transmitted on resources of the corresponding PSSCH.

### Sidelink Communication Scenario

1) Out-of-coverage sidelink communication: Both of two UEs performing sidelink communication are out of network coverage (for example, the UE cannot detect any cell that meets a “cell selection criterion” on a frequency at which sidelink communication needs to be performed, and that means the UE is out of network coverage).

2) In-coverage sidelink communication: Both of two UEs performing sidelink communication are in network coverage (for example, the UE detects at least one cell that meets a “cell selection criterion” on a frequency at which sidelink communication needs to be performed, and that means that the UE is in network coverage).

3) Partial-coverage sidelink communication: One of two UEs performing sidelink communication is out of network coverage, and the other is in network coverage.

From the perspective of the UE side, the UE only has two scenarios, out-of-coverage and in-coverage. Partial-coverage is described from the perspective of sidelink communication.

### Basic Procedure of LTE V2X (Sidelink) Communication

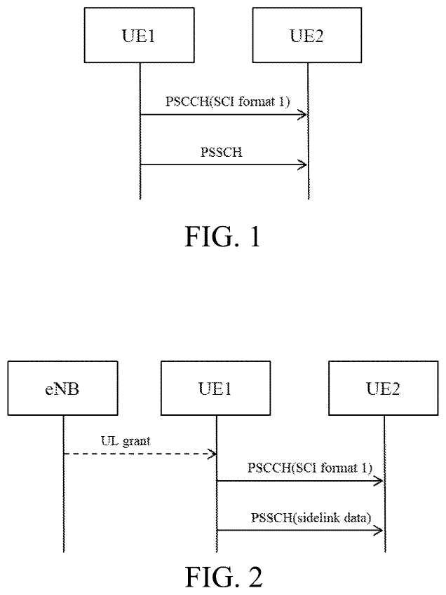

FIG. 1 is a schematic diagram showing sidelink communication of LTE V2X UE. First, UE1 transmits to UE2 sidelink control information (SCI format 1), which is carried by a physical layer channel PSCCH. SCI format 1 includes scheduling information of a PSSCH, such as frequency domain resources and the like of the PSSCH. Secondly, UE1 transmits to UE2 sidelink data, which is carried by the physical layer channel PSSCH. The PSCCH and the corresponding PSSCH are frequency division multiplexed, that is, the PSCCH and the corresponding PSSCH are located in the same subframe in the time domain but are located on different RBs in the frequency domain. Specific design methods of the PSCCH and the PSSCH are as follows:

1) The PSCCH occupies one subframe in the time domain and two consecutive RBs in the frequency domain. Initialization of a scrambling sequence uses a predefined value of 510. The PSCCH may carry SCI format 1, where SCI format 1 at least includes frequency domain resource information of the PSSCH. For example, for a frequency domain resource indication field, SCI format 1 indicates a starting sub-channel number and the number of consecutive sub-channels of the PSSCH corresponding to the PSCCH.

2) The PSSCH occupies one subframe in the time domain, and the PSSCH and the corresponding PSCCH are frequency division multiplexed (FDM). The PSSCH occupies one or a plurality of consecutive sub-channels in the frequency domain. The sub-channels represent n_{subCHsize} consecutive PRBs in the frequency domain, n_{subCHsize} is configured by an RRC parameter, and a starting sub-channel and the number of consecutive sub-channels are indicated by the frequency domain resource indication field of SCI format 1.

### LTE V2X Resource Allocation Modes: Transmission Mode 3/Transmission Mode 4

FIG. 2 shows two LTE V2X resource allocation modes, which are referred to as base station scheduling-based resource allocation (transmission mode 3) and UE sensing-based resource allocation (transmission mode 4), respectively. In LTE V2X, when there is eNB network coverage, a base station can configure, through UE-level dedicated RRC signaling SL-V2X-ConfigDedicated, a resource allocation mode of UE, which may also be referred to as a transmission mode of the UE, and is specifically as follows:

1) Base station scheduling-based resource allocation mode (transmission mode 3): the base station scheduling-based resource allocation mode means that frequency domain resources used in sidelink communication are scheduled by the base station. Transmission mode 3 includes two scheduling modes, which are dynamic scheduling and semi-persistent scheduling (SPS), respectively. For dynamic scheduling, a UL grant (DCI format 5A) includes the frequency domain resources of the PSSCH, and a CRC of a PDCCH or an EPDCCH carrying the DCI format 5A is scrambled by an SL-V-RNTI. For SPS, the base station configures one or a plurality of (at most 8) configured grants through IE: SPS-ConfigSL-r14, and each configured grant includes a grant index and a resource period of the grant. The UL grant (DCI format 5A) includes the frequency domain resource of the PSSCH, indication information (3 bits) of the grant index, and indication information of SPS activation or release (or deactivation). The CRC of the PDCCH or the EPDCCH carrying the DCI format 5A is scrambled by an SL-SPS-V-RNTI.

Specifically, when RRC signaling SL-V2X-ConfigDedicated is set to scheduled-r14, it indicates that the UE is configured in the base station scheduling-based transmission mode. The base station configures the SL-V-RNTI or the SL-SPS-V-RNTI via RRC signaling, and transmits the UL grant to the UE through the PDCCH or the EPDCCH (DCI format 5A, the CRC is scrambled by the SL-V-RNTI or the SL-SPS-V-RNTI). The UL grant includes at least scheduling information of the PSSCH frequency domain resource in sidelink communication. When the UE successfully detects the PDCCH or the EPDCCH scrambled by the SL-V-RNTI or the SL-SPS-V-RNTI, the UE uses a PSSCH frequency domain resource indication field in the UL grant (DCI format 5A) as PSSCH frequency domain resource indication information in a PSCCH (SCI format 1), and transmits the PSCCH (SCI format 1) and a corresponding PSSCH.

For SPS in transmission mode 3, the UE receives, in a downlink subframe n, the DCI format 5A scrambled by the SL-SPS-V-RNTI. If the DCI format 5A includes the indication information of SPS activation, then the UE determines frequency domain resources of the PSSCH according to the indication information in the DCI format 5A, and determines time domain resources of the PSSCH (transmission subframes of the PSSCH) according to information such as the subframe n and the like.

2) UE sensing-based resource allocation mode (transmission mode 4): The UE sensing-based resource allocation mode means that resources used in sidelink communication are based on a procedure of sensing, by the UE, a candidate available resource set. When the RRC signaling SL-V2X-ConfigDedicated is set to ue-Selected-r14, it indicates that the UE is configured in the UE sensing-based transmission mode. In the UE sensing-based transmission mode, the base station configures an available transmission resource pool, and the UE determines a PSSCH sidelink transmission resource in the transmission resource pool according to a certain rule (for a detailed description of the procedure, see the LTE V2X UE sensing procedure section), and transmits a PSCCH (SCI format 1) and a corresponding PSSCH.

### Sidelink Resource Pool

In sidelink, resources transmitted and received by UE all belong to resource pools. For example, for a base station scheduling-based transmission mode in sidelink, the base station schedules transmission resources for sidelink UE in a resource pool; alternatively, for a UE sensing-based transmission mode in sidelink, the UE determines a transmission resource in a resource pool.

### Numerologies in NR (Including NR Sidelink) and Slots in NR (Including NR Sidelink)

A numerology comprises two aspects: a subcarrier spacing and a cyclic prefix (CP) length. NR supports five subcarrier spacings, which are respectively 15 kHz, 30 kHz, 60 kHz, 120 kHz, and 240 kHz (corresponding to μ=0, 1, 2, 3, 4). Table 4.2-1 shows the supported transmission numerologies specifically as follows:

TABLE 4.2-1
Subcarrier Spacings Supported by NR

| μ | Δf = 2^{μ} · 15 [kHz] | CP (cyclic prefix) |
|---|---|---|
| 0 | 15 | Normal |
| 1 | 30 | Normal |
| 2 | 60 | Normal, Extended |
| 3 | 120 | Normal |
| 4 | 240 | Normal |

Only when μ=2, namely, in the case of a 60-kHz subcarrier spacing, is the extended CP supported, and only the normal CP is supported in the case of other subcarrier spacings. For the normal CP, each slot includes 14 OFDM symbols; for the extended CP, each slot includes 12 OFDM symbols. For μ=0, namely, a 15-kHz subcarrier spacing, one slot=1 ms; for μ=1, namely, a 30-kHz subcarrier spacing, one slot=0.5 ms; for μ=2, namely, a 60-kHz subcarrier spacing, one slot=0.25 ms, and so on.

### Parameter Sets in LTE (Including LTE V2X) and Slots and Subframes in LTE (Including LTE V2X)

The LTE only supports a 15 kHz subcarrier spacing. Both the extended CP and the normal CP are supported in the LTE. The subframe has a duration of 1 ms and includes two slots. Each slot has a duration of 0.5 ms.

For the normal CP, each subframe includes 14 OFDM symbols, and each slot in the subframe includes 7 OFDM symbols; for the extended CP, each subframe includes 12 OFDM symbols, and each slot in the subframe includes 6 OFDM symbols.

### Resource Block (RB) and Resource Element (RE)

The resource block (RB) is defined in the frequency domain as N_{sc}^{RB}=12 consecutive subcarriers. For example, for a 15 kHz subcarrier spacing, the RB is 180 kHz in the frequency domain. For a 15 kHz×2^{μ} subcarrier spacing, the resource element (RE) represents one subcarrier in the frequency domain and one OFDM symbol in the time domain.

### Phase-Tracking Reference Signal (PT-RS)

In Rel-15 NR, the PT-RS is used to track phase fluctuations over the entire transmission period (e.g. one slot) on higher frequency bands. Since the PT-RS is designed to track phase noise, the PT-RS is dense in the time domain and sparse in the frequency domain. The PT-RS will only appear together with the DMRS, and will only be transmitted if the network is configured with the PT-RS.

Similarly, a sidelink PT-RS is introduced in NR sidelink. The user equipment performs phase tracking on higher frequency bands according to the received PT-RS, so as to improve demodulation performance.

### Time Domain Pattern of PSSCH DMRS

In NR sidelink, OFDM symbols available for sidelink transmission in a slot are jointly determined by RRC parameters sl-StartSymbol and sl-LengthSymbols. The value range of sl-StartSymbol is OFDM symbols 0 to 7, and the value range of sl-LengthSymbols is 7 to 14 OFDM symbols. For example, if sl-StartSymbol is configured to 3 and sl-LengthSymbols is configured to 9, then in one slot, OFDM symbol 3 to OFDM symbol 11 can be used for sidelink transmission.

In NR sidelink, the position of a DMRS in a slot is as shown in the table below:

TABLE 1
PSSCH DM-RS Time-domain Location

| | DM-RS position | | | | | |
|---|---|---|---|---|---|---|
| | PSCCH (2 symbols) | | | PSCCH (3 symbols) | | |
| l_{d} (the | PSCCH DM-RS | | | PSCCH DM-RS | | |
| number of | symbol number | | | symbol number | | |
| symbols) | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

In the above table, l_{d} represents the number of OFDM symbols for PSSCH transmission in NR sidelink. It is worth noting that the number of OFDM symbols for PSSCH transmission includes an AGC symbol but does not include a gap symbol. The AGC symbol represents an OFDM symbol corresponding to sl-StartSymbol, and the gap symbol represents an OFDM symbol corresponding to (sl-StartSymbol+sl-LengthSymbols−1). Since l_{d} does not include the last symbol available for sidelink, l_{d} ranges from 6 to 13. The numbers listed under DM-RS position in the table refer to relative OFDM numbers relative to the OFDM symbol corresponding to sl-StartSymbol, i.e., the OFDM symbol corresponding to sl-StartSymbol is numbered as 0, and the number 1 refers to the next OFDM symbol following the OFDM symbol corresponding to sl-StartSymbol.

### Resource Mapping of PSSCH DMRS

In NR sidelink, the DMRS for the PSSCH will not be mapped to a resource block (RB) where the PSCCH (and the DMRS for the PSCCH) is located. It is worth noting that the time-domain position of the PSSCH DMRS in the description does not mean that transmission of the PSSCH DMRS is necessarily present on the corresponding OFDM symbol. For example, l_{d}=6, the PSCCH starts from the OFDM symbol corresponding to sl-StartSymbol in the time domain, the number of symbols for the PSCCH is two, and the PSCCH occupies all RBs in the frequency domain for the entire PSSCH transmission. In this case, on the OFDM symbol whose DMRS position is 1 (as shown in Table 1), there will be no PSSCH DMRS transmission, that is, the PSSCH DMRS will not be mapped to the corresponding OFDM symbol. In the description of the present invention, “DMRS not actually transmitted” includes, but is not limited to, the above situation. Similarly, in the description of the present invention, “DMRS actually transmitted” means that a certain OFDM symbol carries a PSSCH DMRS, and “DMRS not actually transmitted” means that a certain OFDM symbol does not carry a PSSCH DMRS.

### Specific Description about r(m) in Embodiment 1

r(m) is equal to

$$\frac{1}{\sqrt{2}} ( 1 - 2 c ( 2 m ) ) + j \frac{1}{\sqrt{2}} ( 1 - 2 c ( 2 m + 1 ) ) ,$$

where the sequence c(n) (corresponding to c in the above formula) is defined as:

c(n)=(x₁(n+N_{c})+x₂(n+N_{c}))mod 2

x₁(n+31)=(x₁(n+3)+x₁(n))mod 2

x₂(n+31)=(x₂(n+3)+x₂(n+2)+x₂(n+1)+x₂(n))mod 2

The above m represents a non-negative integer, j represents the basic unit of imaginary numbers, a mod b represents the remainder obtained by dividing a by b, and N_{c}=1600. For example,

$$r ( 10 ) = \frac{1}{\sqrt{2}} ( 1 - 2 c ( 2 \times 10 ) ) + j \frac{1}{\sqrt{2}} ( 1 - 2 c ( 2 \times 10 + 1 ) ) .$$

The sequence c(n) represents a pseudo-random number sequence. When user equipment determines r(m), the user equipment further needs to determine the values of c(2m) and c(2m+1). For example, the values of c(20) and c(21) need to be determined in the previous example. Determining the sequence c(n) requires simultaneously determining the sequences x₁(n) and x₂(n). For the determination of x₁(n), an initialization sequence of x₁(n) is x₁(0)=1, x₁(n)=0, n=1, 2, . . . , 30. In this way, x₁(n), n>30 can be obtained sequentially according to x₁(n+31)=(x₁(n+3)+x₁(n))mod 2. For example, x₁(31)=x₁(0+31)=(x₁(0+3)+x₁(0))mod 2=(x₁(3)+x₁(0))mod 2. According to the initialization sequence, x₁(31) to x₁(61) can be determined. x₁(62) to x₁(92) are derived from the determined x₁(31) to x₁(61), and so on. For the determination of x₂(n), the method is similar to that for x₁(n), i.e., an initialization sequence of x₂(n) (n=0, 1, 2, . . . , 30) is determined. A decimal representation of the initialization sequence of x₂(n) is cᵢₙᵢₜ=Σᵢ₌₀³⁰x₂(i)×2ⁱ.

Hereinafter, specific examples and embodiments related to the present invention are described in detail. In addition, as described above, the examples and embodiments described in the present disclosure are illustrative descriptions for facilitating understanding of the present invention, rather than limiting the present invention.

### Embodiment 1

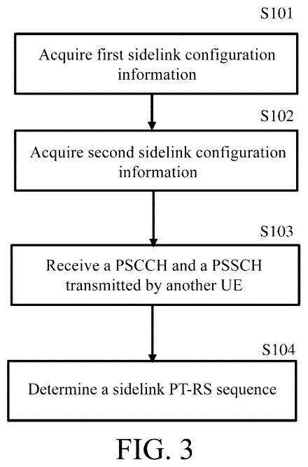

FIG. 3 is a schematic diagram showing a basic procedure of a method performed by user equipment according to Embodiment 1 of the present invention.

The method performed by user equipment according to Embodiment 1 of the present invention is described in detail below in conjunction with the basic procedure diagram shown in FIG. 3.

As shown in FIG. 3, in Embodiment 1 of the present invention, the steps performed by user equipment include the following:

In step S101, optionally, sidelink user equipment acquires first sidelink configuration information.

Optionally, the first sidelink configuration information is transmitted by a base station gNB, or is pre-configured.

Optionally, the first sidelink configuration information at least includes indication information sl-StartSymbol and sl-LengthSymbols of OFDM symbols used for sidelink in a slot.

In step S102, the user equipment acquires second sidelink configuration information.

Optionally, the second sidelink configuration information is transmitted by the base station gNB, or is pre-configured.

Optionally, the second sidelink configuration information at least includes configuration information of a sidelink phase-tracking reference signal (PT-RS).

In step S103, optionally, the sidelink user equipment receives a PSCCH and a corresponding PSSCH transmitted by another user equipment.

The PSCCH carries first stage SCI, and the corresponding PSSCH carries second stage SCI.

Optionally, the user equipment determines, according to at least the first stage SCI and the second sidelink configuration information, that the other user equipment has transmitted a sidelink PT-RS, or determines that a sidelink PT-RS is present.

In step S104, the sidelink user equipment determines a sequence for the sidelink PT-RS.

Optionally, the sequence r(m) for the sidelink PT-RS is equal to

$$\frac{1}{\sqrt{2}} ( 1 - 2 c ( 2 m ) ) + j \frac{1}{\sqrt{2}} ( 1 - 2 c ( 2 m + 1 ) ) ,$$

where the sequence c(n) is defined as:

c(n)=(x₁(n+N_{c})+x₂(n+N_{c}))mod 2

x₁(n+31)=(x₁(n+3)+x₁(n))mod 2

x₂(n+31)=(x₂(n+3)+x₂(n+2)+x₂(n+1)+x₂(n))mod 2
where N_{c}=1600, and an initialization sequence of x₁(n) is x₁(0)=1, where x₁(n)=0, n=1, 2, . . . , 30. An initialization sequence of x₂(n) is cᵢₙᵢₜ=Σᵢ₌₀^{30x}₂(i)×2ⁱ=(2¹⁷(N_{symb}^{slotn}_{s,f}^{μ}+1+1)(2N_{ID}+1)+2N_{ID})mod 2³¹, where N_{ID}=N_{ID}^{X} mod 2¹⁶, N_{ID}^{X} is equal to the decimal representation of cyclic redundancy check (CRC) code on the PSCCH, N_{symb}^{slot} indicates the number of OFDM symbols within the slot, n_{s,f}^{μ} indicates the slot index of (the sidelink PT-RS or a DMRS for the corresponding PSSCH) within a frame. l represents the symbol index of the first OFDM symbol that actually transmits a DMRS for the corresponding PSSCH within the slot.
Or,
optionally, l represents the symbol index of the first OFDM symbol that carries a DMRS for the corresponding PSSCH within the slot.

Optionally, the first OFDM symbol that actually transmits a DMRS for the corresponding PSSCH or the first OFDM symbol that carries a DMRS for the corresponding PSSCH is at least determined by the first sidelink configuration information, the first stage SCI, and the second sidelink configuration information.

### Embodiment 2

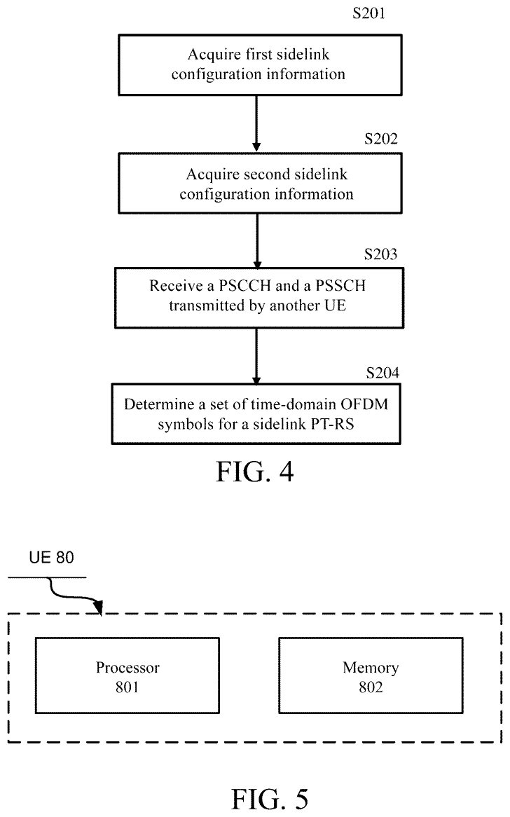

FIG. 4 is a schematic diagram showing a basic procedure of a method performed by user equipment according to Embodiment 2 of the present invention.

The method performed by user equipment according to Embodiment 2 of the present invention is described in detail below in conjunction with the basic procedure diagram shown in FIG. 4.

As shown in FIG. 4, in Embodiment 2 of the present invention, the steps performed by user equipment include the following:

In step S201, sidelink user equipment acquires sidelink configuration information.

Optionally, the sidelink configuration information is transmitted by a base station gNB, or is pre-configured.

Optionally, the sidelink configuration information at least includes indication information sl-StartSymbol and sl-LengthSymbols of OFDM symbols used for sidelink in a slot.

In step S202, the user equipment acquires second sidelink configuration information.

Optionally, the second sidelink configuration information is transmitted by the base station gNB, or is pre-configured.

Optionally, the second sidelink configuration information at least includes configuration information of a sidelink phase-tracking reference signal (PT-RS).

In step S203, optionally, the sidelink user equipment receives a PSCCH and a corresponding PSSCH transmitted by another user equipment.

The PSCCH carries first stage SCI, and the corresponding PSSCH carries second stage SCI.

Optionally, the user equipment determines, according to at least the first stage SCI and the second sidelink configuration information, that the other user equipment has transmitted a sidelink PT-RS, or determines that a sidelink PT-RS is present.

Optionally, the user equipment determines a time-domain density L_{PT-RS} of the sidelink PT-RS according to at least the first stage SCI and the second sidelink configuration information.

In step S204, the sidelink user equipment determines a set of time-domain OFDM symbols for the sidelink PT-RS.

Optionally, the method used by the sidelink user equipment to determine a set of time-domain OFDM symbols for the sidelink PT-RS includes, but is not limited to, the following:

l_{ref} is numbered relative to the start symbol of the PSSCH transmission (the start symbol of the PSSCH transmission represents the first symbol following the AGC symbol, that is, l_{ref}=0 corresponds to the OFDM symbol corresponding to sl-StartSymbol+1).
1. Set the following parameters: i=0 and l_{ref}=0.
2. If any OFDM symbol in the symbol interval [max(l_{ref}+(i−1)×L_{PT-RS}+1, l_{ref}), . . . , l_{ref}+i×L_{PT-RS}] overlaps with any symbol that actually transmits a DMRS for the corresponding PSSCH (or, any symbol that carries a DMRS for the corresponding PSSCH), then
set parameter i=1;
set l_{ref} to the index of the symbol that contains the actually transmitted DMRS;
if l_{ref}+i×L_{PT-RS} is within the OFDM symbol range of the PSSCH transmission, then repeat the above steps from step 2.
3. Add l_{ref}+i×L_{PT-RS} to the set of time-domain symbols for the sidelink PT-RS.
4. Increase the parameter i by 1.
5. If l_{ref}+i×L_{PT-RS} is within the OFDM symbol range of the PSSCH transmission, then repeat the above steps from step 2; otherwise, optionally end the execution of all steps 1-5.

Optionally, the any OFDM symbol that actually transmits a DMRS for the corresponding PSSCH or the any OFDM symbol that carries a DMRS for the corresponding PSSCH is determined at least by the first sidelink configuration information, the first stage SCI, and the second sidelink configuration information.

FIG. 5 is a block diagram showing user equipment (UE) according to the present invention. As shown in FIG. 5, user equipment (UE) 80 includes a processor 801 and a memory 802. The processor 801 may include, for example, a microprocessor, a microcontroller, an embedded processor, and the like. The memory 802 may include, for example, a volatile memory (such as a random access memory (RAM)), a hard disk drive (HDD), a non-volatile memory (such as a flash memory), or other memories. The memory 802 stores program instructions. The instructions, when run by the processor 801, can implement the above method performed by user equipment as described in detail in the present invention.

The method and related equipment according to the present invention have been described above in combination with preferred embodiments. It should be understood by those skilled in the art that the method shown above is only exemplary, and the above embodiments can be combined with one another as long as no contradiction arises. The method of the present invention is not limited to the steps or sequences illustrated above. The network node and user equipment illustrated above may include more modules. For example, the network node and user equipment may further include modules that can be developed or will be developed in the future to be applied to a base station, an MME, or UE, and the like. Various identifiers shown above are only exemplary, and are not meant for limiting the present invention. The present invention is not limited to specific information elements serving as examples of these identifiers. A person skilled in the art could make various alterations and modifications according to the teachings of the illustrated embodiments.

It should be understood that the above-described embodiments of the present invention may be implemented by software, hardware, or a combination of software and hardware. For example, various components of the base station and user equipment in the above embodiments can be implemented by multiple devices, and these devices include, but are not limited to: an analog circuit device, a digital circuit device, a digital signal processing (DSP) circuit, a programmable processor, an application specific integrated circuit (ASIC), a field programmable gate array (FPGA), and a complex programmable logic device (CPLD), and the like.

In the present application, the “base station” may refer to a mobile communication data and control exchange center with large transmission power and a wide coverage area, including functions such as resource allocation and scheduling, data reception and transmission. “User equipment” may refer to a user mobile terminal, for example, including terminal devices that can communicate with a base station or a micro base station wirelessly, such as a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic causes the processor to perform the operations (the method) described in the embodiments of the present invention. Such setting of the present invention is typically provided as software, codes and/or other data structures provided or encoded on the computer readable medium, e.g., an optical medium (e.g., compact disc read-only memory (CD-ROM)), a flexible disk or a hard disk and the like, or other media such as firmware or micro codes on one or more read-only memory (ROM) or random access memory (RAM) or programmable read-only memory (PROM) chips, or a downloadable software image, a shared database and the like in one or more modules. Software or firmware or such configuration may be installed on a computing device such that one or more processors in the computing device perform the technical solutions described in the embodiments of the present invention.

In addition, each functional module or each feature of the base station device and the terminal device used in each of the above embodiments may be implemented or executed by a circuit, which is usually one or more integrated circuits. Circuits designed to execute various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general purpose processor may be a microprocessor, or the processor may be an existing processor, a controller, a microcontroller, or a state machine. The aforementioned general purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-3. (canceled)

4: A user equipment, comprising:
a processor; and
a memory storing instructions,
wherein the instructions, when run by the processor, cause the user equipment to:
receive a sidelink phase tracking reference signal; and
determine a sequence of the sidelink phase tracking reference signal based on an index of the first symbol carrying an associated DMRS for a PSSCH.

5: A user equipment, comprising:
a processor; and
a memory storing instructions,
wherein the instructions, when run by the processor, cause the user equipment to:
generate a sidelink phase tracking reference signal;
transmit the sidelink phase tracking reference signal; and
determine a sequence of the sidelink phase tracking reference signal based on an index of the first symbol carrying an associated DMRS for a PSSCH.

6: A method performed by user equipment, the method comprising:
receiving a sidelink phase tracking reference signal; and
determining a sequence of the sidelink phase tracking reference signal based on an index of the first symbol carrying an associated DMRS for a PSSCH.
